(19) United States
(12) Patent Application Publication
(10) Pub. No.: US 2012/0143661 A1
(43) Pub. Date: Jun. 7, 2012

(54) Interactive E-Poster Methods and Systems

(75) Inventors: Brian F. Roberts, Dallas, TX (US); Raul I. Aldrey, Plano, TX (US)

(73) Assignee: VERIZON PATENT AND LICENSING, INC., Basking Ridge, NJ (US)

(21) Appl. No.: 12/959,877

(22) Filed: Dec. 3, 2010

(51) Int. Cl. G06Q 30/00; G06F 3/048

(52) U.S. Cl. 705/14.4; 715/764

(57) ABSTRACT

An exemplary method includes an enhanced content access system identifying a media content instance as being of interest to a user, including, in response to the identifying of the media content instance as being of interest to the user, an interactive e-poster corresponding to the media content instance within a library of e-posters associated with the user, and providing enhanced content associated with the media content instance for experiencing by the user by way of the interactive e-poster. Corresponding methods and systems are also disclosed.

### BACKGROUND INFORMATION

As media content distribution and processing technologies have advanced, media outlets through which advertisements are distributed have increased both in number and type. The increased number and type of media outlets have provided a variety of platforms that may be used by advertisers to distribute advertisement content to potential consumers. For example, set-top box devices and other media content access devices are often capable of receiving and/or delivering advertisement content to users. The delivered advertisement content may be associated with one of a variety of products for sale. For example, an advertisement may promote a media content instance, such as a pay-per-view event, a video-on-demand program, a movie to be shown in theaters, music, and/or any other type of media content instance.

However, it is sometimes difficult to generate user interest in an advertised media content instance through traditional advertisements. This is due at least in part to various limitations associated with traditional advertisements. For example, traditional broadcast advertisements are limited to a relatively short amount of time to generate user interest in a media content instance being advertised. Hence, alternative approaches to generating interest in advertised media content instances are desirable.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary enhanced content access system according to principles described herein.

FIG. 2 illustrates an exemplary implementation of the system of FIG. 1 according to principles described herein.

FIG. 3 illustrates another exemplary implementation of the system of FIG. 1 according to principles described herein.

FIG. 4 illustrates an exemplary method of providing access to enhanced content associated with a media content instance by way of an interactive e-poster according to principles described herein.

FIG. 5 shows a screenshot of an advertisement that may be presented to a user of a media content access subsystem according to principles described herein.

FIG. 6 shows an exemplary physical movie poster according to principles described herein.

FIG. 7 shows an exemplary graphical user interface (“GUI”) of a movie library that may be provided for display by a media content access subsystem according to principles described herein.

FIG. 8 shows an exemplary interactive e-poster according to principles described herein.

FIG. 9 shows the interactive e-poster of FIG. 8 after a user has selected a display element included in the interactive e-poster according to principles described herein.

FIG. 10 shows additional enhanced content that may be displayed within the interactive e-poster of FIG. 8.

FIG. 11 illustrates another exemplary method of providing access to enhanced content associated with a media content instance by way of an interactive e-poster according to principles described herein.

FIG. 12 illustrates an exemplary computing device according to principles described herein.

### DETAILED DESCRIPTION OF PREFERRED EMBODIMENTS

Exemplary methods and systems for providing access to enhanced content associated with a media content instance by way of an interactive e-poster are described herein. As described in more detail below, an enhanced content access system may identify a media content instance as being of interest to a user, include, in response to the identifying of the media content instance as being of interest to the user, an interactive e-poster corresponding to the media content instance within a library of e-posters associated with the user, and provide enhanced content associated with the media content instance for experiencing by the user by way of the interactive e-poster.

As used herein, an “interactive e-poster” may include any graphical depiction of a poster associated with a media content instance (e.g., a movie) and that may be provided for display by a media content access device (e.g., a set-top box device, a mobile phone device, etc.). For example, an interactive e-poster may be substantially identical in appearance to a physical promotional poster for a media content instance.

An interactive e-poster may be configured to serve as a portal to enhanced content associated with the media content instance. For example, as will be described in more detail below, an interactive e-poster may include one or more selectable display elements representative of, linked to, or otherwise associated with one or more enhanced content instances. Each display element may include text (e.g., one or more words, characters, numbers, symbols, etc.), one or more images, one or more videos, one or more graphics, animation content (e.g., Flash content), one or more hyperlinks, and/or any other content that may be visually depicted in the interactive e-poster and that may be representative of or otherwise provide access to an enhanced content instance.

As used herein, the terms “media content” and “media content instance” may refer to any television program, on-demand media program, pay-per-view media program, broadcast media program (e.g., broadcast television program), IPTV media content, advertisement (e.g., commercial), video, movie (e.g., a movie scheduled for presentation in theaters on a certain date), song, image, photograph, sound, or any segment, component, or combination of these or other forms of media content that may be viewed or otherwise experienced by a user.

As used herein, the terms “enhanced content” and “enhanced content instance” may include any content associated with a media content instance that may be of interest to a user and that may be accessed by way of an interactive e-poster associated with the media content instance. For example, enhanced content may include, but is not limited to, social networking content associated with the purchased media content instance, Internet-based content associated with the purchased media content instance, content associated with personnel associated with the purchased media content instance, rating content associated with the purchased media content instance, one or more scenes included within the purchased media content instance, production content associated with the purchased media content instance, one or more scenes deleted from the purchased media content instance, one or more alternative scenes associated with the purchased media content instance, trivia associated with the purchased media content instance, one or more advertisements for one or more objects associated with the purchased media content instance, one or more opportunities to purchase tickets to a presentation of the media content instance, one or more platform-specific formats of the purchased media content instance, and/or any other content associated with a media content instance and that may be accessed by a user.

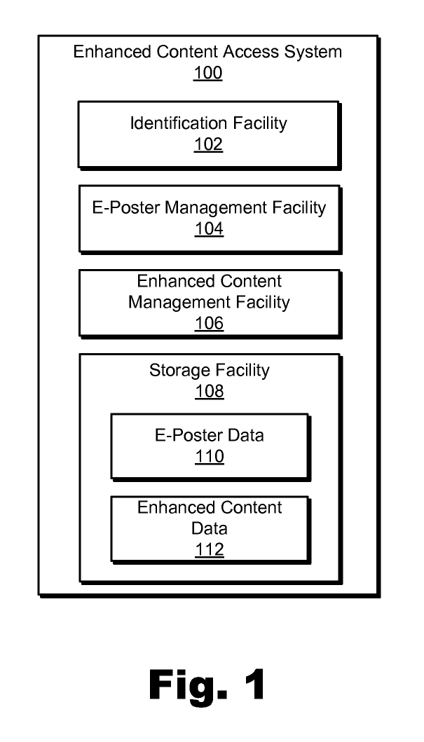

FIG. 1 illustrates an exemplary enhanced content access system 100 (or simply “system 100”). As will be described in more detail below, system 100 may be configured to facilitate access by a user to enhanced content associated with a media content instance by way of an interactive e-poster.

System 100 may include, but is not limited to, an identification facility 102, an e-poster management facility 104, an enhanced content management facility 106, and a storage facility 108, which may be in communication with one another using any suitable communication technologies. It will be recognized that although facilities 102-108 are shown to be separate facilities in FIG. 1, any of facilities 102-108 may be combined into fewer facilities, such as into a single facility, or divided into more facilities as may serve a particular implementation.

Identification facility 102 may be configured to identify a media content instance as being of interest to a user. In some examples, the identification may be performed in response to user input provided by the user indicating that the user is interested in the media content instance. Additionally or alternatively, the identification may be performed automatically (e.g., in accordance with a user profile associated with the user). Various manners in which identification facility 102 may identify a media content as being of interest to a user will be described in more detail below.

E-poster management facility 104 may be configured to manage (e.g., generate, maintain, provide access to, etc.) one or more interactive e-posters associated with one or more media content instances. For example, e-poster management facility 104 may be configured to include, in response to identification facility 102 identifying a media content instance as being of interest to a user, an interactive e-poster corresponding to the media content instance within a library of e-posters associated with the user (e.g., by inserting or placing the interactive e-poster into the library of e-posters associated with the user). The interactive e-poster may be configured to serve as a portal to enhanced content associated with the media content instance. An example of e-poster management facility 104 including an interactive e-poster within a library of e-posters will be provided below.

It will be recognized that the library of e-posters associated with the user may include any number of e-posters. In some examples, the library may be empty (i.e., not include any e-posters) when the interactive e-poster is included therein.

Enhanced content management facility 106 may be configured to manage (e.g., generate, select, maintain, provide, etc.) enhanced content associated with one or more media content instances. For example, enhanced content management facility 106 may provide enhanced content associated with a media content instance for experiencing by a user by way of an interactive e-poster associated with the media content instance.

Enhanced content management facility 106 may provide the enhanced content by way of the interactive e-poster in any suitable manner. For example, enhanced content management facility 106 may link selectable display elements included in the interactive e-poster with corresponding enhanced content instances associated with the media content instance. The user may select one or more of the display elements to access one or more of the enhanced content instances. Exemplary manners in which enhanced content management facility 106 may provide enhanced content by way of an interactive e-poster will be described in more detail below.

In some examples, enhanced content management facility 106 may dynamically update the enhanced content provided by way of an interactive e-poster associated with a media content instance based on an interaction of the user with the interactive e-poster. For example, a user may perform one or more touch gestures (e.g., a “reverse-pinch” touch gesture) to “zoom in” within an interactive e-poster. In response, enhanced content management facility 106 may dynamically update the enhanced content instances (and/or the display elements associated with the enhanced content instances) to provide additional or alternative enhanced content associated with the media content instance.

Storage facility 108 may be configured to maintain e-poster data 110 representative of one or more e-posters (e.g., interactive e-posters) and enhanced content data 112 representative of one or more enhanced content instances. Storage facility 108 may be configured to maintain additional or alternative data as may serve a particular implementation.

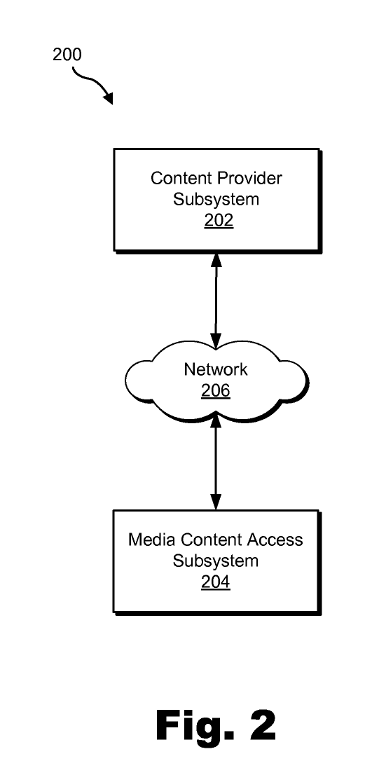

FIG. 2 illustrates an exemplary implementation 200 of system 100 wherein a content provider subsystem 202 (or simply “provider subsystem 202”) is communicatively coupled to a media content access subsystem 204 (or simply “access subsystem 204”). As will be described in more detail below, identification facility 102, e-poster management facility 104, enhanced content management facility 106, and storage facility 108 may each be implemented by one or both of provider subsystem 202 and access subsystem 204.

Provider subsystem 202 and access subsystem 204 may communicate using any communication platforms and technologies suitable for transporting data and/or communication signals, including known communication technologies, devices, media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, wireless communication technologies, in-band and out-of-band signaling technologies, and other suitable communications networks and technologies.

In certain embodiments, provider subsystem 202 and access subsystem 204 may communicate via a network 206, which may include one or more networks, including, but not limited to, wireless networks (Wi-Fi networks), (e.g., wireless communication networks), mobile telephone networks (e.g., cellular telephone networks), closed media networks, open media networks, closed communication networks, open communication networks, satellite networks, navigation networks, broadband networks, narrowband networks, voice communication networks (e.g., VoIP networks), the Internet, local area networks, and any other networks capable of carrying data and/or communications signals between provider subsystem 202 and access subsystem 204. Communications between provider subsystem 202 and access subsystem 204 may be transported using any one of the above-listed networks, or any combination or sub-combination of the above-listed networks.

While FIG. 2 shows provider subsystem 202 and access subsystem 204 communicatively coupled via network 206, it will be recognized that provider subsystem 202 and access subsystem 204 may be configured to communicate one with another in any other suitable manner (e.g., via a direct connection).

In some examples, provider subsystem 202 may be configured to generate or otherwise provide media content (e.g., in the form of one or more media content streams including one or more media content instances), data associated with one or more media content instances (e.g., e-poster data, enhanced content data, etc.), and/or any other type of data to access subsystem 204.

Access subsystem 204 may be configured to facilitate access by a user to media content received from provider subsystem 202. To this end, access subsystem 204 may present the media content for experiencing (e.g., viewing) by a user, record the media content, and/or analyze data associated with the media content (e.g., analyze a stream of text and/or metadata associated with the media content). Presentation of the media content may include, but is not limited to, displaying, playing, or otherwise presenting the media content, or one or more components of the media content, such that the media content may be experienced by the user.

Additionally or alternatively, access subsystem 204 may be configured to provide a user with access to enhanced content associated with one or more media content instances by way of one or more interactive e-posters. For example, access subsystem 204 may be configured to display an interactive e-poster corresponding to a media content instance within a display screen associated with access subsystem 204. The interactive e-poster may include one or more selectable display elements representative of one or more enhanced content instances associated with the media content instance. A user may access the one or more enhanced content instances by selecting the one or more selectable display elements.

In certain embodiments, system 100 may be implemented entirely by or within provider subsystem 202 or access subsystem 204. In other embodiments, components of system 100 may be distributed across provider subsystem 202 and access subsystem 204. For example, access subsystem 204 may include a client (e.g., a client application) implementing one or more of the facilities of system 100.

Provider subsystem 202 may be implemented by one or more computing devices. For example, provider subsystem 202 may be implemented by one or more server devices. Additionally or alternatively, access subsystem 204 may be implemented as may suit a particular implementation. For example, access subsystem 204 may be implemented by one or more media content access devices, which may include, but are not limited to, a set-top box device, a DVR device, a media content processing device, a communications device, a mobile access device (e.g., a mobile phone device, a handheld device, a laptop computer, a tablet computer, a personal-digital assistant device, a camera device, etc.), a personal computer, a gaming device, a television device, and/or any other device configured to perform one or more of the processes and/or operations described herein.

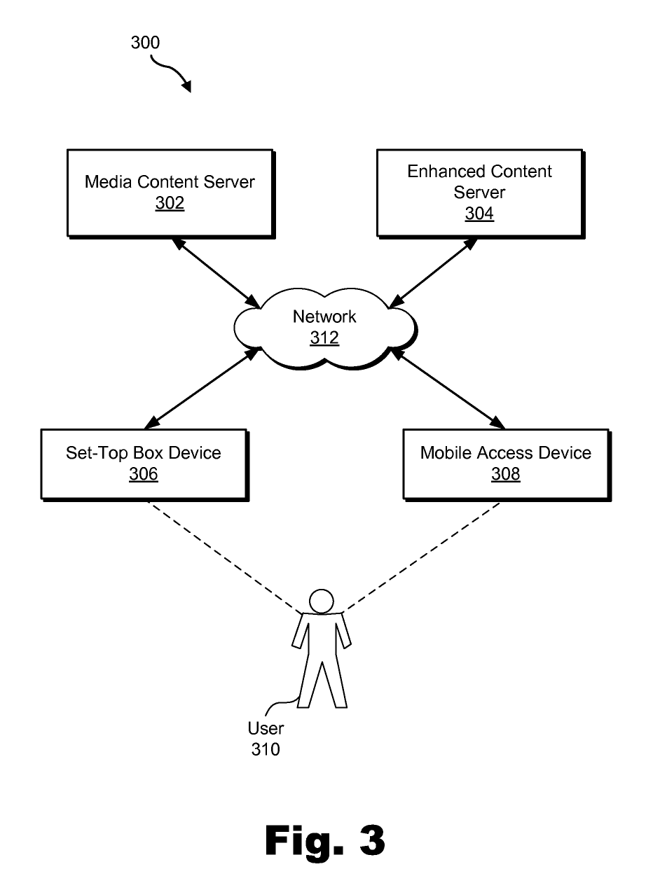

To illustrate, FIG. 3 shows another exemplary implementation 300 of system 100 wherein provider subsystem 202 is implemented by a media content server 302 and an enhanced content server 304, and access subsystem 204 is implemented by a set-top box device 306 (or simply “STB device 306”) and a mobile access device 308 (or simply “mobile device 308”). Both STB device 306 and mobile device 308 may be associated with (e.g., used by) a user 310. Implementation 300 may additionally or alternatively include any other type of server and/or access device as may serve a particular implementation.

In some examples, media content server 302 may be configured to maintain and/or provide media content and/or any related information (e.g., e-poster data, metadata, etc.) associated with the media content to STB device 306 and/or mobile device 308. Enhanced content server 304 may include or provide access to one or more enhanced content sources, such as the enhanced content sources described herein. Media content server 302, enhanced content server 304, set-top box device 306, and mobile device 308 may be configured to communicate by way of a network 312, which may include one or more of the networks described herein.

In certain embodiments, components of system 100 may be distributed across media content server 302, enhanced content server 304, set-top box device 306, and/or mobile access device 308. For example, user 310 may utilize mobile access device 308 to provide user input indicative of an interest by the user in a particular media content instance. Data identifying the media content instance may be transmitted from mobile access device 308 to media content server 302, which may provide an interactive e-poster associated with the media content instance for inclusion in a library of e-posters accessible by user 310 by way of set-top box device 306 and/or mobile access device 308. Enhanced content server 304 may provide one or more enhanced content instances that may be accessed by user 310 by way of the interactive e-poster.

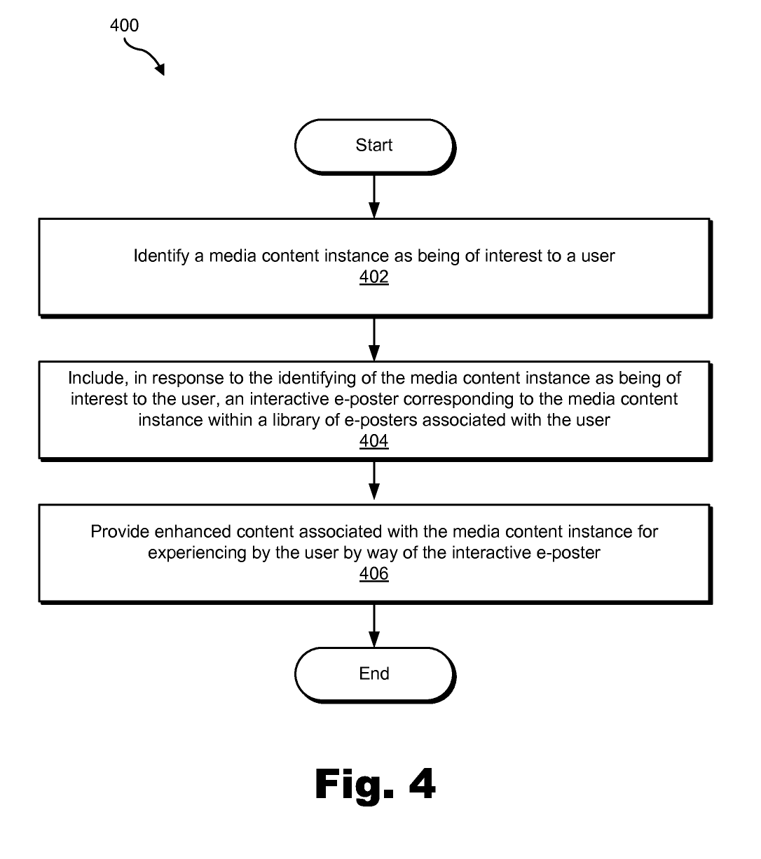

FIG. 4 illustrates an exemplary method 400 of providing access to enhanced content associated with a media content instance by way of an interactive e-poster. While FIG. 4 illustrates exemplary steps according to one embodiment, other embodiments may omit, add to, reorder, and/or modify any of the steps shown in FIG. 4. One or more of the steps shown in FIG. 4 may be performed by any component or combination of components of system 100, content provider subsystem 202, media content access subsystem 204, media content server 302, enhanced content server 304, set-top box device 306, and/or mobile access device 308.

In step 402, a media content instance is identified as being of interest to a user. Various examples of identifying a media content instance as being of interest to a user will now be provided. It will be recognized that the examples provided herein are merely illustrative of the many different manners in which step 402 may be performed.

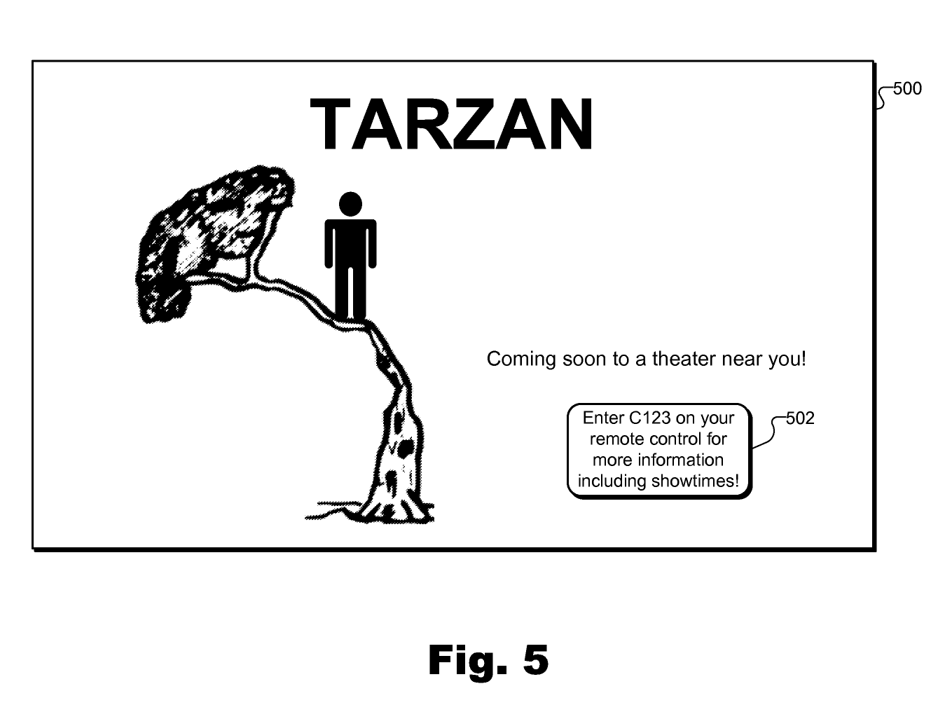

In some examples, system 100 may identify a media content instance as being of interest to a user by receiving, in response to a presented advertisement for the media content instance, a request input by the user to access additional information associated with the media content instance. For example, FIG. 5 shows a screenshot of an advertisement 500 (e.g., commercial, trailer, etc.) that may be presented to a user of a media content access subsystem 204. Advertisement 500 may be presented during a broadcast of a television program and/or in any other manner as may serve a particular implementation. As shown in FIG. 5, advertisement 500 may be configured to promote a movie entitled “Tarzan” that is about to be released in theaters.

In some examples, as shown in FIG. 5, a selectable trigger 502 may be presented along with advertisement 500. Selectable trigger 502 may direct a viewer of advertisement 500 to press a sequence of input buttons on a remote control device or the like in order to input a request to access additional information associated with the movie “Tarzan.” In some examples, selectable trigger 502 may be specific to a particular subscriber television network (e.g., the Verizon® FIOS® network) such that only users of the particular subscriber television network may access the additional information by pressing the displayed sequence of input buttons. It will be recognized that selectable trigger 502 may be applicable to a user of any subscriber network. In some alternative examples, selectable trigger 502 may include a hyperlink or other trigger that may be selected by a user in order to identify or flag the movie as being one of interest to the user.

In some examples, the request to access additional information associated with the movie “Tarzan” may be received prior to a scheduled release time of the movie. Accordingly, enhanced content associated with the movie may be provided for experiencing by the user prior to the scheduled release time. As used herein, a “scheduled release time” of a media content instance refers to a particular time in the future at which the media content instance becomes available for access by one or more users. For example, a scheduled release time may refer to a date and/or time at which a new movie becomes available in theaters and/or by way of access subsystem 204, a broadcast time of a pay-per-view event, and/or any other time at which a media content instance becomes available for access by one or more users.

Allowing users to access enhanced content by way of an interactive e-poster associated with a media content instance before a scheduled release time of the media content instance may result in the users having a more fulfilling and enjoyable experience with the media content instance when it is released. Moreover, allowing users to access enhanced content by way of an interactive e-poster associated with a media content instance may incentivize the users to pre-order access to the media content instance or purchase tickets to the media content instance, motivate users to purchase access to the media content instance through a particular content provider (e.g., through a subscriber television provider as opposed to through an online or retail store), and/or allow a producer of the media content instance to promote and/or gauge interest in the media content instance.

Additionally or alternatively, system 100 may identify a media content instance as being of interest to a user by detecting, in response to user input provided by the user, an identification code (“ID code”) printed on a physical poster associated with the media content instance and identifying the media content instance based on the detected ID code.

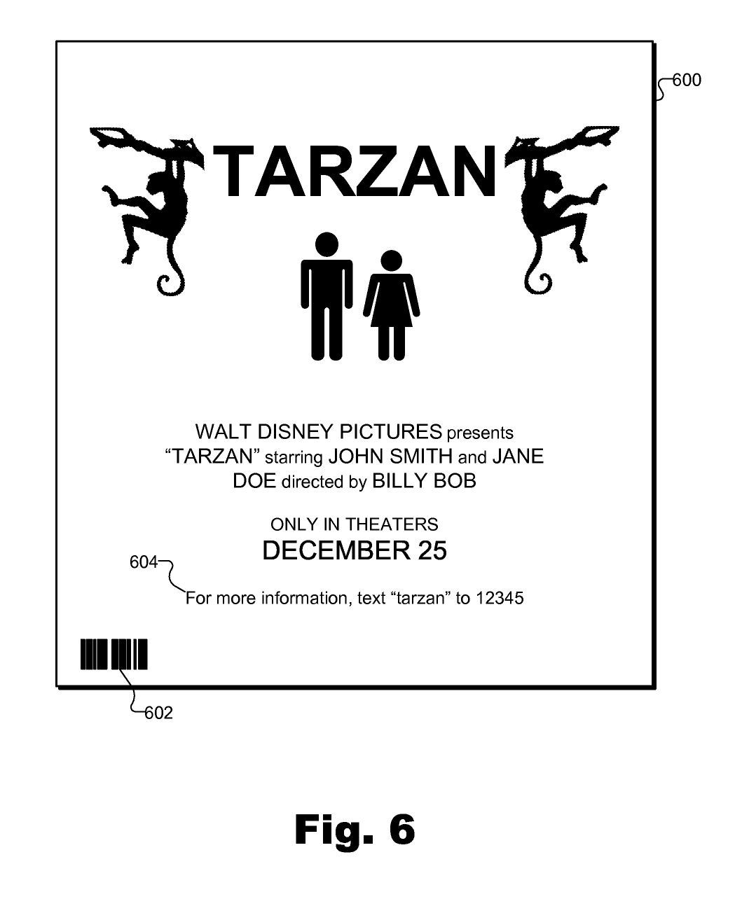

To illustrate, FIG. 6 shows a physical movie poster 600 associated with the movie “Tarzan.” As shown in FIG. 6, poster 600 may include an ID code 602 printed thereon. ID code 602 may include a bar code and/or any other type of information that may be detected by system 100 and used to identify the movie associated with code 602.

In some examples, a mobile access device (e.g., mobile access device 308) utilized by a user may detect ID code 602. For example, poster 600 may be located within a movie theater. A person at the movie theater may see poster 600 and desire to learn more about the “Tarzan” movie associated with poster 600. To this end, the person may utilize his or her mobile access device to detect ID code 602. The mobile access device may detect ID code 602 in any suitable manner (e.g., by using an infrared scanner, camera, or the like). Based on the detected ID code 602, the mobile access device (or any other device communicatively coupled to the mobile access device) may determine that ID code 602 is representative of the “Tarzan” movie and automatically include an interactive e-poster corresponding to the “Tarzan” movie within a library of e-posters associated with the user.

Additionally or alternatively, poster 600 may include directions printed thereon specifying a manner in which a user may specify that he or she is interested in the movie associated with poster 600. For example, poster 600 includes directions 604 indicating that a user may send a text message to a particular number. System 100 may be configured to receive the text message and include an interactive e-poster in a library of e-posters associated with the user in response to receiving the text message.

Additionally or alternatively, system 100 may identify a media content instance as being of interest to a user by receiving, during a presentation of an advertisement for the media content instance, user input provided by the user that indicates interest by the user in the media content instance. In response to the user input, system 100 may detect at least one of an audio attribute and a visual attribute of the advertisement and identify the media content instance based on the detected at least one of the audio attribute and the visual attribute.

For example, a user may view an advertisement (e.g., a trailer) for a movie on a television device. During the advertisement, the user may decide that he or she is interested in the movie. The user may accordingly provide an input command to a mobile access device (e.g., mobile access device 308) to detect an audio attribute (e.g., a soundtrack accompanying the advertisement) and/or a visual attribute (e.g., one or more images included in the advertisement). The mobile access device (or any other device communicatively coupled to the mobile access device) may use the detected audio and/or visual attribute to identify the movie and automatically include an interactive e-poster corresponding to the movie within a library of e-posters associated with the user. It will be recognized that the mobile access device may detect the audio and/or visual attribute of the advertisement in any suitable manner. For example, the mobile access device may take a picture of the advertisement using a camera included in the mobile access device. System 100 may then apply one or more image processing heuristics to the picture to identify the movie associated with the advertisement.

Additionally or alternatively, system 100 may identify a media content instance as being of interest to a user by receiving, during a presentation of an advertisement for the media content instance, user input provided by the user that indicates interest by the user in the media content instance, detecting, in response to the user input, metadata associated with the advertisement and identifying the media content instance based on the detected metadata.

To illustrate, a user may go to a movie theater to watch a movie. During the previews that traditionally precede the movie, the user may see a trailer for another movie (e.g., a movie scheduled for release at a later date) that causes the user to become interested in the other movie. During the presentation of the trailer, the user may utilize a mobile access device (e.g., mobile access device 308) to provide user input (e.g., one or more user input commands) indicating that the user is interested in the movie corresponding to the trailer being presented. In response to receiving the user input, the mobile access device may detect metadata associated with the advertisement. The metadata may be transmitted by one or more devices associated with the movie theater, for example, and may include information identifying the movie corresponding to the trailer. Accordingly, the mobile access device (or any other device communicatively coupled to the mobile access device) may identify the movie based on the metadata and automatically include an interactive e-poster corresponding to the movie within a library of e-posters associated with the user.

As mentioned, system 100 may be configured to automatically identify a media content instance as being of interest to a user based on a user profile associated with the user. The user profile may represent one or more one or more personal traits and/or preferences associated with the user, how the user interacts with access subsystem 204, and/or any other information associated with the user as may serve a particular implementation. For example, the user profile may indicate that the user prefers a particular genre of movies and/or movies that feature a particular actor. Accordingly, system 100 may automatically identify one or more media content instances that may be of interest to the user based on the indicated preferences.

Returning to FIG. 4, in step 404, in response to the identifying of the media content instance as being of interest to the user, an interactive e-poster corresponding to the media content instance is included within a library of e-posters associated with the user. The interactive e-poster may be configured to serve as a portal to enhanced content associated with the media content instance.

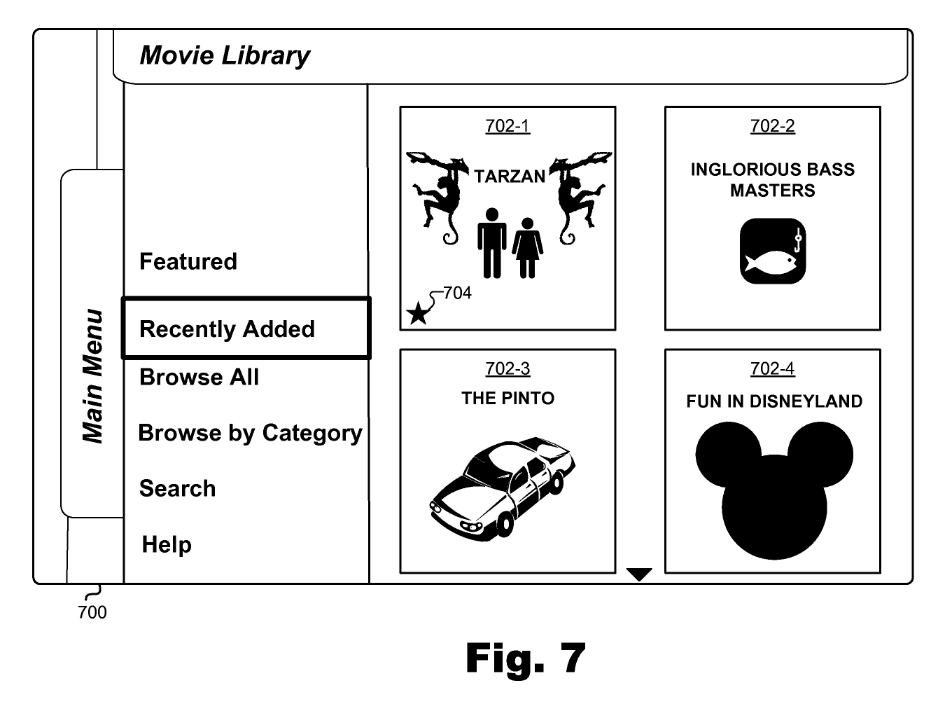

To illustrate, FIG. 7 shows an exemplary graphical user interface (“GUI”) 700 of a movie library that may be provided for display by media content access subsystem 204. As shown, the movie library may include a library of e-posters 702 (e.g., e-posters 702-1 through 702-4) each corresponding to a particular movie. One or more of e-posters 702 may be interactive (i.e., serve as portals to enhanced content). The movie library may be associated with a media content player (e.g., Windows Media Player, Quicktime, an iPod, etc.), for example, and may be accessed by a user to browse through the various e-posters 702 included in the library, select one or more movies for presentation, access enhanced content associated with one or more movies included in the library, and/or otherwise interact with the movies included in the library.

Some of the e-posters 702 included in the movie library may correspond to movies that the user has in his or her collection (i.e., movies that the user may watch at any time). Additionally or alternatively, some of the e-posters 702 may correspond to movies not yet accessible to the user. These e-posters 702 may serve as virtual placeholders for not yet released movies that the user is interested in and may be used to access enhanced content associated with the not yet released movies.

To illustrate, interactive e-poster 702-1 corresponds to the same movie “Tarzan” used in the examples described above and was included in the movie library shown in FIG. 7 in response to a user indicating interest in the movie. A display element 704 may be included in interactive e-poster 702-1 to visually indicate that the movie “Tarzan” is not yet accessible (i.e., that it will be released at a future date). As will be described below, interactive e-poster 702-1 may be used to access enhanced content associated with the movie “Tarzan” prior to the scheduled release time of the movie.

Returning to FIG. 4, in step 406, enhanced content associated with the media content instance of interest to the user is provided for experiencing by the user by way of the interactive e-poster. Step 406 may be performed in any suitable manner as may serve a particular implementation.

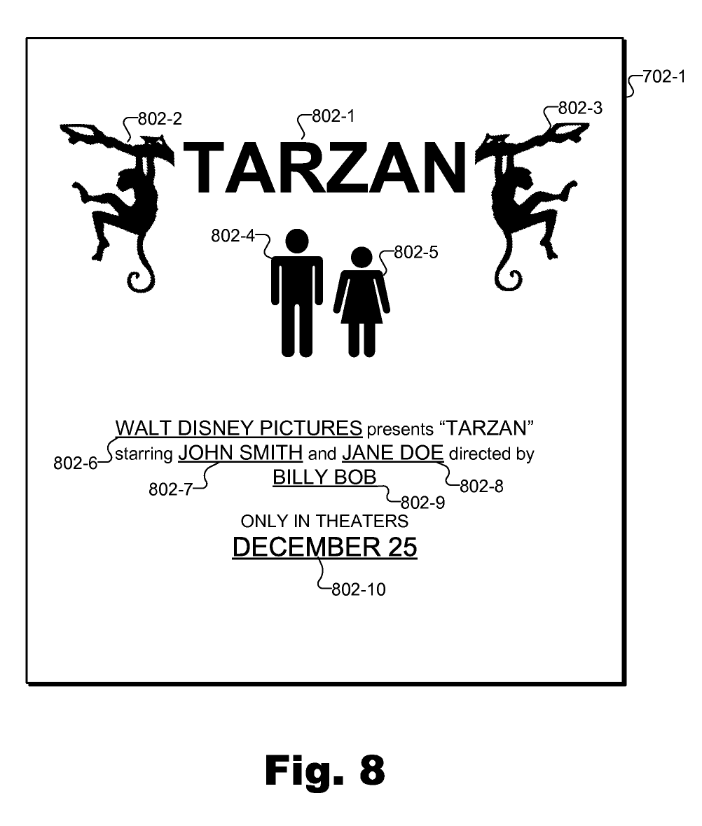

For example, a user may select interactive e-poster 702-1 from the movie library depicted in GUI 700. In response, a larger version (e.g., a full screen version) of interactive e-poster 702-1 may be displayed within a display screen associated with access subsystem 204, as shown in FIG. 8. Interactive e-poster 702-1 may be used by a user to access enhanced content associated with the movie “Tarzan.”

To illustrate, various selectable display elements 802 (e.g., 802-1 through 802-10) may be included within interactive e-poster 702-1. Each selectable display element 802 may be representative of, linked to, or otherwise associated with one or more enhanced content instances. Hence, a user may access enhanced content associated with the movie “Tarzan” by simply selecting (e.g., touching) one or more of display elements 802.

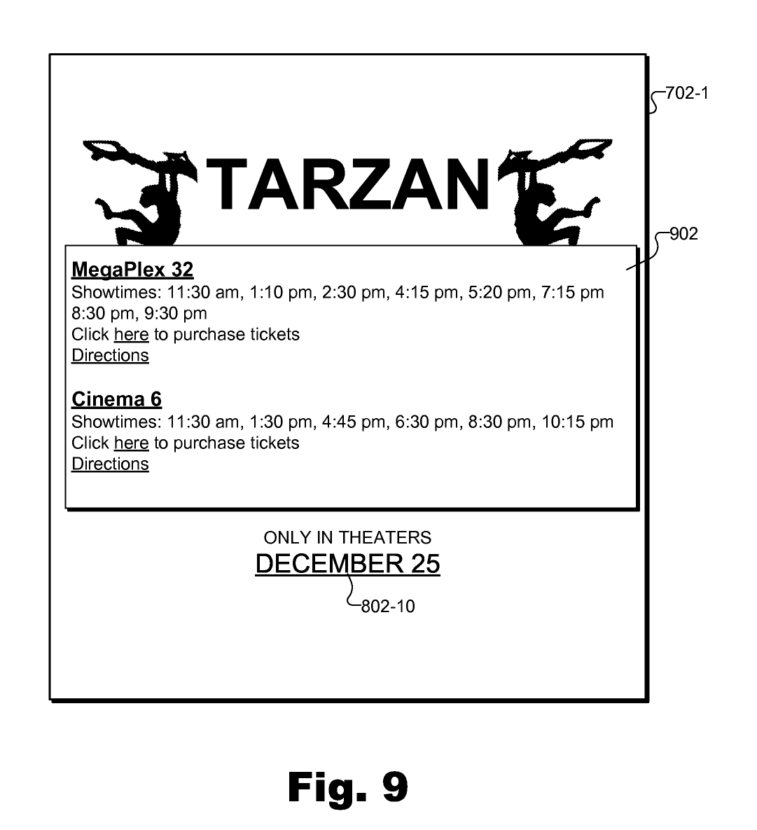

For example, FIG. 9 shows interactive e-poster 702-1 after the user has selected display element 802-10. As shown in FIG. 9, enhanced content 902 representative of a listing of available showtimes, links to purchase tickets to one or more showings, and links to directions to various theaters showing the movie “Tarzan” may be displayed within interactive e-poster 702-1 in response to the selection of display element 802-10.

It will be recognized that other types of enhanced content may be similarly presented within interactive e-poster 702-1 in response to a selection of any of the other display elements 802. For example, a user may select graphical object 802-4 to access enhanced content related to a particular character in the movie.

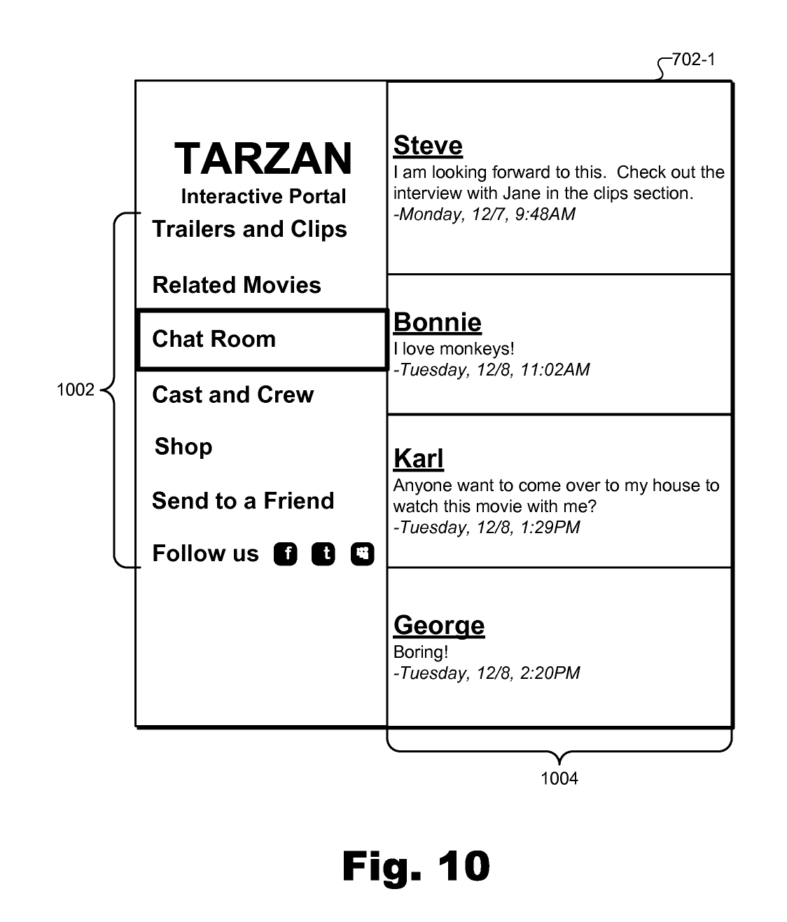

As mentioned, system 100 may dynamically update the enhanced content provided by way of interactive e-poster 702-1 based on an interaction of the user with the interactive e-poster. For example, returning to FIG. 7, a user may perform one or more touch gestures (e.g., a “reverse-pinch” touch gesture) to “zoom in” within interactive e-poster 702-1. In response, system 100 may dynamically provide additional or alternative enhanced content instances within interactive e-poster 702-1. To illustrate, FIG. 10 shows additional enhanced content associated with the movie “Tarzan” after the user has zoomed in within interactive e-poster 702-1. As shown in FIG. 10, the additional enhanced content may include a list of options 1002 associated with the movie “Tarzan” and social networking content 1004 associated with the movie “Tarzan.” It will be recognized that additional or alternative enhanced content associated with the movie “Tarzan” may be displayed in the interactive e-poster 702-1 shown in FIG. 10 as may serve a particular implementation. In some examples, one or more animation effects may be used to visually depict a zooming in or out within interactive e-poster 702-1.

As has also been mentioned, enhanced content associated with a media content instance may be provided for experiencing by way of an interactive e-poster prior to a scheduled release time of the media content instance. The enhanced content may also be provided for experiencing by way of the interactive e-poster after the media content has been released. The type of available enhanced content may be dynamically modified throughout the “lifetime” of the media content instance in order to maintain interest by the user in the media content instance.

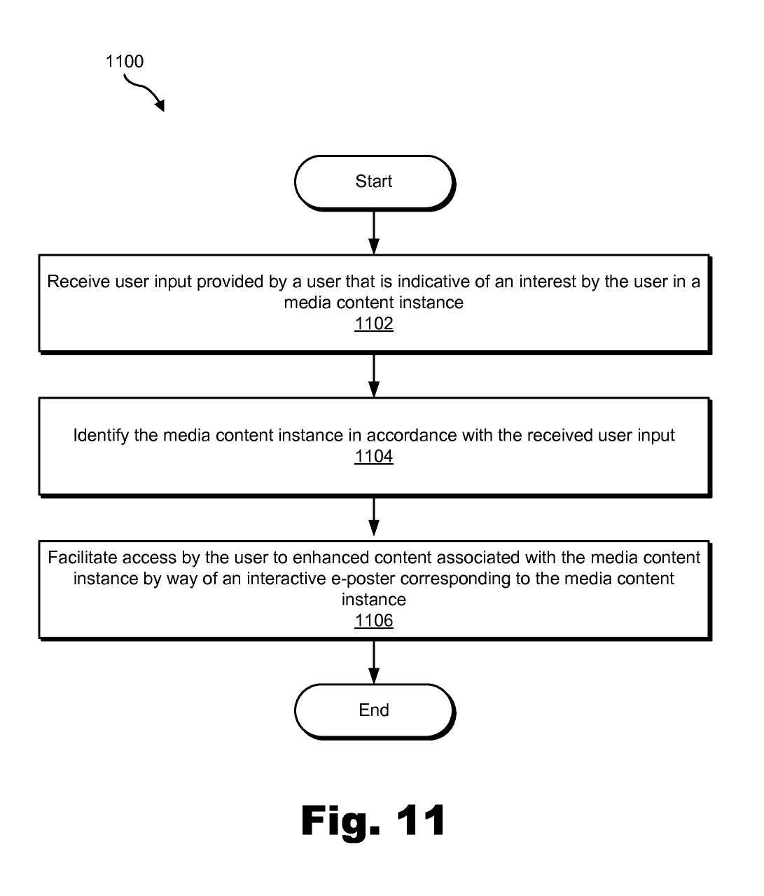

FIG. 11 illustrates another exemplary method 1100 of providing access to enhanced content associated with a media content instance by way of an interactive e-poster. While FIG. 11 illustrates exemplary steps according to one embodiment, other embodiments may omit, add to, reorder, and/or modify any of the steps shown in FIG. 11. One or more of the steps shown in FIG. 11 may be performed by any component or combination of components of system 100, content provider subsystem 202, media content access subsystem 204, media content server 302, enhanced content server 304, set-top box device 306, and/or mobile access device 308.

In step 1102, user input provided by a user that is indicative of an interest by the user in a media content instance is received. Step 1102 may be performed in any of the ways described herein.

In step 1104, the media content instance is identified in accordance with the received user input. Step 1104 may be performed in any of the ways described herein.

In step 1106, access by the user to enhanced content associated with the media content instance is facilitated by way of an interactive e-poster corresponding to the media content instance. Step 1106 may be performed in any of the ways described herein.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

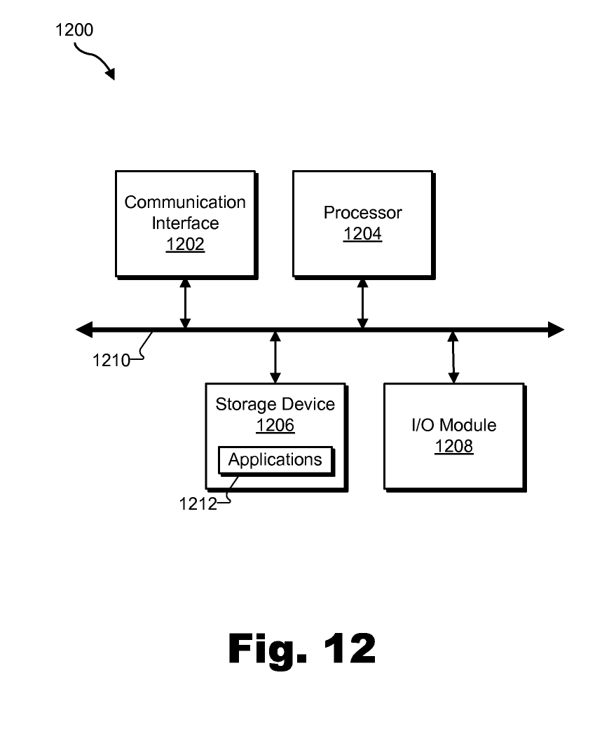

FIG. 12 illustrates an exemplary computing device 1200 that may be configured to perform one or more of the processes described herein. As shown in FIG. 12, computing device 1200 may include a communication interface 1202, a processor 1204, a storage device 1206, and an input/output (“I/O”) module 1208 communicatively connected via a communication infrastructure 1210. While an exemplary computing device 1200 is shown in FIG. 12, the components illustrated in FIG. 12 are not intended to be limiting. Additional or alternative components may be used in other embodiments. Components of computing device 1200 shown in FIG. 12 will now be described in additional detail.

Communication interface 1202 may be configured to communicate with one or more computing devices. Examples of communication interface 1202 include, without limitation, a wired network interface (such as a network interface card), a wireless network interface (such as a wireless network interface card), a modem, and any other suitable interface. In at least one embodiment, communication interface 1202 may provide a direct connection between system 100 and one or more provisioning systems via a direct link to a network, such as the Internet. Communication interface 1202 may additionally or alternatively provide such a connection through, for example, a local area network (such as an Ethernet network), a personal area network, a telephone or cable network, a satellite data connection, a dedicated URL, or any other suitable connection. Communication interface 1202 may be configured to interface with any suitable communication media, protocols, and formats, including any of those mentioned above.

Processor 1204 generally represents any type or form of processing unit capable of processing data or interpreting, executing, and/or directing execution of one or more of the instructions, processes, and/or operations described herein. Processor 1204 may direct execution of operations in accordance with one or more applications 1212 or other computer-executable instructions such as may be stored in storage device 1206 or another computer-readable medium.

Storage device 1206 may include one or more data storage media, devices, or configurations and may employ any type, form, and combination of data storage media and/or device. For example, storage device 1206 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1206. For example, data representative of one or more executable applications 1212 (which may include, but are not limited to, one or more of the software applications described herein) configured to direct processor 1204 to perform any of the operations described herein may be stored within storage device 1206. In some examples, data may be arranged in one or more databases residing within storage device 1206.

I/O module 1208 may be configured to receive user input and provide user output and may include any hardware, firmware, software, or combination thereof supportive of input and output capabilities. For example, I/O module 1208 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1208 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1200. For example, one or more applications 1212 residing within storage device 1206 may be configured to direct processor 1204 to perform one or more processes or functions associated with identification facility 102, e-poster management facility 104, and/or enhanced content management facility 106. Likewise, storage facility 108 may be implemented by or within storage device 1206.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
identifying, by an enhanced content access system, a media content instance as being of interest to a user;
including, by the enhanced content access system in response to the identifying of the media content instance as being of interest to the user, an interactive e-poster corresponding to the media content instance within a library of e-posters associated with the user; and
providing, by the enhanced content access system, enhanced content associated with the media content instance for experiencing by the user by way of the interactive e-poster.

2. The method of claim 1, wherein the identifying of the media content instance as being of interest to the user comprises receiving, in response to a presented advertisement for the media content instance, a request input by the user to access additional information associated with the media content instance.

3. The method of claim 2, wherein the request is received and the enhanced content is provided prior to a scheduled release time of the media content instance.

4. The method of claim 2, further comprising wherein the request input by the user comprises a selection of a selectable trigger presented along with the advertisement.

5. The method of claim 1, wherein the identifying of the media content instance as being of interest to the user comprises:
detecting, in response to user input provided by the user, an identification code printed on a physical poster associated with the media content instance, and
identifying the media content instance based on the detected identification code.

6. The method of claim 1, wherein the identifying of the media content instance as being of interest to the user comprises:
receiving, during a presentation of an advertisement for the media content instance, user input provided by the user that indicates interest by the user in the media content instance;
detecting, in response to the user input, at least one of an audio attribute and a visual attribute of the advertisement; and
identifying the media content instance based on the detected at least one of the audio attribute and the visual attribute.

7. The method of claim 6, wherein the advertisement comprises a trailer for the media content instance.

8. The method of claim 1, wherein the identifying of the media content instance as being of interest to the user comprises:
receiving, during a presentation of an advertisement for the media content instance, user input provided by the user that indicates interest by the user in the media content instance;
detecting, in response to the user input, metadata associated with the advertisement; and
identifying the media content instance based on the detected metadata.

9. The method of claim 8, wherein the metadata is transmitted by a movie theater during a presentation of the advertisement for the media content instance.

10. The method of claim 1, wherein the identifying is performed automatically in accordance with a user profile associated with the user.

11. The method of claim 1, wherein the interactive e-poster is configured to serve as a portal to the enhanced content.

12. The method of claim 1, wherein the providing of the enhanced content by way of the interactive e-poster comprises linking one or more selectable display elements included in the interactive e-poster with one or more enhanced content instances.

13. The method of claim 1, further comprising dynamically updating, by the enhanced content access system, the enhanced content provided by way of the interactive e-poster based on an interaction of the user with the interactive e-poster.

14. The method of claim 1, wherein the enhanced content comprises at least one of social networking content associated with the media content instance, Internet-based content associated with the media content instance, content associated with personnel associated with the media content instance, rating content associated with the media content instance, one or more scenes included within the media content instance, production content associated with the media content instance, one or more scenes deleted from the media content instance, one or more alternative scenes associated with the media content instance, trivia associated with the media content instance, one or more advertisements for one or more objects associated with the media content instance, one or more opportunities to purchase tickets to a presentation of the media content instance, and one or more platform-specific formats of the media content instance.

15. The method of claim 1, wherein the media content instance comprises at least one of a movie, a video-on-demand program, a pay-per-view event, a live broadcast of an event, and a song.

16. The method of claim 1, embodied as computer-executable instructions on at least one non-transitory computer-readable medium.

17. A method comprising:
receiving, by an enhanced content access system, user input provided by a user that is indicative of an interest by the user in a media content instance;
identifying, by the enhanced content access system, the media content instance in accordance with the received user input; and
facilitating, by the enhanced content access system, access by the user to enhanced content associated with the media content instance by way of an interactive e-poster corresponding to the media content instance.

18. The method of claim 17, wherein the facilitating access by the user to the enhanced content comprises automatically including the interactive e-poster within a library of e-posters associated with the user.

19. The method of claim 17, embodied as computer-executable instructions on at least one non-transitory computer-readable medium.

20. A system comprising:
an identification facility configured to identify a media content instance as being of interest to a user;
an e-poster management facility communicatively coupled to the identification facility and configured to include, in response to the identifying of the media content instance as being of interest to the user, an interactive e-poster corresponding to the media content instance within a library of e-posters associated with the user; and
an enhanced content management facility communicatively coupled to the e-poster management facility and configured to provide enhanced content associated with the media content instance for experiencing by the user by way of the interactive e-poster.
